(19) United States
(12) Patent Application Publication
(10) Pub. No.: US 2004/0178072 A1
(43) Pub. Date: Sep. 16, 2004

(54) Gel for electrophoresis and uses thereof

(76) Inventors: Anthony Royce Goodall, Narangba (AU); Ben Herbert, North Epping (AU)

Correspondence Address: BOZICEVIC, FIELD & FRANCIS LLP, 200 MIDDLEFIELD RD, SUITE 200, MENLO PARK, CA, 94025, US

(21) Appl. No.: 10/477,709

(22) PCT Filed: Jun. 13, 2002
(86) PCT No.: PCT/AU02/00768

(30) Foreign Application Priority Data
Jun. 14, 2001 (AU) PR5695

(51) Int. Cl. G01N 27/453

(52) U.S. Cl. 204/459; 204/469; 204/610

(57) ABSTRACT

An immobilised pH gradient (IPG) gel comprising a polymerised mixture of monomers comprising: (I) CH₂═CR₁—CO—NR₂R₃, (II) (CH₂═CHCONHCH₂CH₂S—)₂ (BAC) and optionally (III) a non-reducible crosslinker, wherein R₁, R₂ and R₃ are the same or different and are hydrogen or optionally substituted alkyl or cycloakyl.

### FIELD OF THE INVENTION

The present invention relates to an improved gel for electrophoresis and to separating and/or analysing at least one macromolecule in a sample.

### BACKGROUND OF THE INVENTION

In the field of analysing macromolecules, one-dimensional and two-dimensional gel electrophoresis have become standard tools for separating and visualizing macromolecules.

One-dimensional gel electrophoresis is used to separate mixtures of macromolecules such as proteins into individual components according to differences in mass by electrophoresing in a polyacrylamide gel under denaturing conditions.

Two-dimensional gel electrophoresis involves isoelectric focusing to separate proteins electrophoretically on the basis of their relative contents of acidic and basic residues. Under the influence of an applied electric field, a more highly charged protein will move faster than a less highly charged protein of similar size and shape. If the proteins are made to move from a sample zone through a non-convecting medium (typically a gel such as polyacrylamide), an electrophoretic separation will result. When the protein enters a region that has a pH value at which the protein's net charge is zero (the isoelectric point, pl), it will cease to migrate relative to the medium. Further, if the migration occurs through a pH gradient that increases monotonically from the anode, the protein will “focus” at its isoelectric point. Two proteins having different ratios of charged or titrating amino acids can be separated therefore by virtue of their different isoelectric points.

One embodiment of an isoelectric focusing gel is an immobilised pH gradient (IPG) gel in which buffering groups responsible for the formation of the pH gradient are acrylamide derivatives co-polymerised into the gel with acrylamide and a cross-linker. These derivatives are called “Immobilines” by the manufacturer, Pharmacia. A gradient of these “Immobiline” groups is cross-linked to polyacrylamide. The polyacrylamide of commercial IPGs are cross-linked by bis-acrylamide or piperazine di-acrylamide (PDA).

Polyacrylamide gels comprising polyacrylamide cross-linked by bis-acrylamide are primarily the medium of choice for protein analysis. Importantly, proteornic studies require comprehensive coverage of proteins contained in the system of interest. Unfortunately, currently available gels are non-dissolvable and repeatedly show retention of proteins in the IPG strips after transfer to the second dimension. e.g. membrane proteins. Compounding this problem, once resolved onto the second dimension, further retention and losses occur with preceding manipulations. Although yields approach 80-90% recovery using traditional methods i.e. mechanical, electro-elution, and diffusion methods, total recovery is rarely achieved. Further, chemical disruption of the gel matrix can often modify the protein altering its native characteristics, and have negative impacts on later identification. Even routine procedures such as Western blotting can often result in loss of proteins from arrays. In each step of a 2D procedure, the currently available gels inevitably cause information loss through protein retention in the matrix.

In 1976, J. N. Hansen developed a dissolvable gel matrix by substituting Bis-acrylamide with Bis-Acryloyl-Cystamine (BAC) as the cross-linker. BAC has a similar structure to bisacrylamide, however it contains a disulfide bond that can be easily disrupted under mild reducing conditions, for example, by reducing agents such as β-mercaptoethanol or dithiotheitol. Cleavage of the disulphide bonds causes the gel to re-solubilise and release any protein within the matrix. Since only the cross-linker is disrupted, long acrylamide polymer chains (containing reduced portions of BAC) are still present which can be removed when necessary by methods such as column chromatography, or ultra-centrifugation.

Most work with gel matrices containing BAC has primarily centered on molecular applications. Due to the nature of the disulphide bonds this method of separation has been used for separating and analysing highly basic chromosomal proteins. Gel matrices containing BAC are currently used for histone purification, DNA and RNA isolation, myosin heavy chains and immuno-precipitated antigen. The gel matrices vary from simple SDS-PAGE to acid-urea and agarose-acrylamide (BAC) composite gels.

Gels containing BAC are currently not considered useful for separating and analysing reduced protein preparations (for example thiol containing proteins) as they interact with the BAC matrices. Furthermore, methods of analysis and separation requiring the prior reduction of samples are not suitable for use on these gels due to BAC's sensitivity to reducing agents.

### DESCRIPTION OF THE INVENTION

The present invention, in its various embodiments, provides gels which have application in electrophoresis and methods for electrophoresis. Preferably, these gels have improved features including one or more of the following:

a) improved pre-fractionation and/or purifying or concentrating a macromolecule from a complex mixture,

b) enhanced entry of macromolecules including high molecular weight components,

c) improved macromolecule transfer between dimensions,

d) improved macromolecule transfer efficiency during blotting,

e) greater efficiency in tryptic digestion of protein spots, and/or

f) greater peptide recovery from tryptic digested proteins.

The present inventors have found that an improved IPG gel for electrophoresis may be obtained by forming a hybrid matrix of polyacrylamide and a reducible cross-linker such as bis-acryloyl cystamine (BAC) (CH₂═CHCONHCH₂CH₂S—)₂. As used herein it is understood that BAC refers to substituted or unsubstituted BAC. Preferably the hybrid gel shows improved non-retention of proteins, and is dissolvable.

Further, it has been found that the gels of the present invention may be designed to allow entry and focusing of high molecular weight components within the sample.

The IPG gels of varying pH gradients may include a non-reducible cross-linker as well as the reducible cross-linker, for example, a combination of PDA and BAC. This use of a combination of non-reducible and reducible cross-linkers provides the possibility of controlling the physical structure of the gel following contact with a reducing agent. For example, by appropriate selection of the ratio of the non-reducible cross-linker to reducible cross-linker, the solubility of the gel may range from total solubility, in which case all gel structure is lost, to partial solubility, where some or substantially all of the gel structure is maintained. An advantage of retaining some of the gel structure is that gross dispersion/diffusion of solubilized proteins may be avoided.

The inclusion of a non-reducible cross-linker also allows control of the pore size of the gel by cleaving all or some of the disulphide links of the BAC derived unit.

For example, the IPG gel may be partially solubilised during rehydration to allow entry and focussing of high molecular weight molecules, for example, glycoproteins and mucins; or during electrophoresis or after electrophoresis to provide improved release and/or transfer of macromolecules (eg. proteins, peptides, protein complexes or mucins).

In an alternate aspect, the present invention is directed to a reducible cross-linked gel comprising a single percent T or a polyacrylamide gradient. Preferably, the reducible cross-linker is BAC. In one embodiment the gel is an SDS-PAGE gel. In one embodiment, the gel comprises agarose. Preferably, this gel provides enhanced transfer efficiency to a membrane during Western Blotting. A BAC cross-linked SDS-PAGE gel may also demonstrate improved peptide recovery after trypsin digestion for Mass Spectrometry analysis. In one embodiment, a gel spot is dissolved before or after digestion with trypsin. Preferably, this is performed using a 100% BAC cross-linked gel.

Preferably, a BAC-agarose composite gel is suitable for use in proteornic studies of mucins, proteins, glycoproteins and other macromolecules.

Accordingly, in a first aspect, the present invention provides an immobilised pH gradient (IPG) gel comprising a polymerised mixture of monomers comprising (I) at least one compound of formula CH₂═CR₁—CO—NR₂R₃, (II) (CH₂═CHCONHCH₂CH₂S—)₂ (BAC) and optionally (III) at least one non-reducible cross-linker, wherein R₁, R₂, and R₃ are the same or different and are hydrogen or optionally substituted alkyl or cycloalkyl. Preferably R₁, R₂ and R₃ are H.

In one embodiment of the first aspect of the invention, BAC is the sole cross-linker, that is, a non-reducible cross-linker is not used. As already mentioned above, such a gel may be completely solubilized by cleavage of the disulpride bonds of BAC.

Preferably stock solutions of BAC are prepared using a substantially organic solvent such as Formamide. Preferably, BAC exhibits improved storage stability in formamide solutions, compared to aqueous solutions. In addition, preferably, the use of formamide results in BAC cross-linked gels which are easier to dissolve by reduction and require less TEMED in the polymerisation step. In one embodiment minimisation of TEMED, by using formamide, is important for gels with % T greater than 8% because it eliminates the need for pre-running the gel to remove excess TEMED in another embodiment, organic solvents, such as, for example, dimethyl formamide and dimethyl sulfoxide are used to completely or partially replace formamide.

In one embodiment, the use of formamide as a solvent for acrylamide and its cross-linker is used for the analysis of RNA and DNA molecules.

In one embodiment, preparation of Acrylamido Buffers with, for example, formamide, forms alkaline pH IPG gradients cross-linked with BAC. Preferably, preparation of all Acrylamido Buffers using an organic solvent such as formamide provides BAC cross-linked IPG's that are more stable and are fully soluble under mild reducing conditions across the pH limits as described herein.

In a preferred embodiment, the IPG gel comprises a mixture of acrylamide and BAC.

In one embodiment, the IPG gel comprises about 1% to about 30% T, more preferably about 2% to 20% T. Preferably the gel comprises about 2% to about 15% T, more preferably comprises about 2% to about 10% T, preferably about 3% to about 6% T, and most preferably about 4% T.

In one embodiment, the IPG gel comprises about 1% C to about 8.5% C. Preferably the gel comprises about 2% C to about 6% C, more preferably about 3% C to about 5% C and most preferably about 4% C.

In a preferred embodiment of the first aspect of the invention, the IPG gel comprises 4% T/4% C.

Preferably, the IPG gel is made using a 20% T/4% C acrylamide-BAC stock.

In another embodiment, the IPG gel is formed by polymerising a monomer mixture comprising (I), a reducible cross-linker (II) and a non-reducible cross-linker (III).

By the term “non-reducible cross-linker” as used herein we mean a cross-linker that substantially retains its cross-linking bonds in the gel under the mildly reducing conditions at which the disulphide bonds of BAC derived units cleave. Preferably, a non-reducible cross-linker contains no disulfide bond and thus is not able to be cleaved by reducing conditions.

Preferably, the inclusion of compound (III) in the monomer mixture provides the ability to control the degree to which the IPG gel maintains its structure following breaking of the disulfide bonds of the BAC derived units under mildly reducing conditions. Thus, by varying the percentage ratio of a combination of cross-linkers (reducible(BAC) and non-reducible(III)) allows at least the partial solubilisation of the gel matrix while retaining some of the gel structure provided by the non-reducible cross-linker Preferably, the gel structure is partially maintained by PDA or bis-acrylamide, thus preventing gross dispersion/diffusion of solubilised proteins.

Preferably the molar ratio of unit (II): unit (III) is about 1:5 to about 5:1, more preferably the molar ratio is about 1:4 to about 4:1, more preferably about 1:3 to about 3:1, more preferably about 1:2 to about 2:1 and most preferably about 1:1.

Non-limiting examples of the non-reducible cross-linker (III) are bis-acrylamide and PDA and N, N′-diallyl tartardiamide (DATD) or a combination thereof.

In a preferred embodiment, the gel comprises a mixture of acrylamide, BAC and PDA.

Preferably the IPG gel comprises 4% T/2.5% C using 40% T/12.5% C acrylamide-BAC stock mixed with 40% T/2.5% C acrylamide-PDA stock.

The IPG gel of the first aspect of the invention may be in the form of a strip or a slab. Preferably, the slab is suitable for use in a multicompartment electrophoresis (MCE) apparatus.

In a second aspect, the present invention provides a method of separating or analysing macromolecules in a sample comprising performing isoelectric focussing on a sample using an IPG gel of the invention as described herein.

The macromolecule may be a proteinaceous molecule such as a protein, peptide, glycoprotein, or a mucin. The mucin may be a high molecular weight mucin.

The sample may be selected from the group consisting of tissue samples, glandular secretions, cell samples, microorganism samples, and culture samples. Preferred examples of samples include E. coli, plasma and saliva samples.

Preferably, the method further comprises treating the sample.

Preferably, treating the sample comprises alkylating existing protein thiols or reducing and alkylating the cysteine residues of a macromolecule in the sample.

Such treatment may be employed to prevent interactions with the BAC matrix in relation to the cystine/cysteine containing proteins within the sample. Preferably, alkylation neutralises any excess thiols present after sample reduction is complete.

The alkylation may be selected from the group consisting of: carboxymethylation, carboxamidomethylation, pyridylethylation, amidopropionylation, dimethylamidopropionylation, N-isopropylcarboxyamidomethylation. Preferably, protein reductants are selected from the group consisting of: thiol reductants, such as dithiothreitol and mercaptoethanol and phosphine reductants, such as tributylphosphine.

The method of the second aspect of the invention may include the further step of solubilising or partially solubilising the IPG gel followed by further separation step(s) or recovery of the macromolecule.

The method of the second aspect may further comprise transferring the IPG gel to a second dimension gel and at least partially solubilising the IPG gel to release the macromolecules to the second gel. Preferably, the method further comprises performing electrophoresis on the second gel.

In one embodiment the term transferring refers to placing the IPG gel on top of the second dimension gel. Preferably, electrophoresis on the second dimension gel is in a direction perpendicular to that used for the IPG gel.

In another embodiment, the IPG gel is placed on top of a non-sieving, large pore size, stacking gel which is cast on top of the sieving second dimension gel.

The second gel may be a denaturing (ie SDS-PAGE) or native gel or an IPG gel.

In an alternate embodiment, the method further comprises excising a fraction containing macromolecules from the IPG gel.

The IPG gel may be stained to visualise a macromolecule contained therein.

Preferably, the excised fraction is solubilised to release a macromolecule contained therein. In one embodiment, the excised fraction is solubilised in sample buffer containing DTT. Preferably the excised and solubilised fraction is re-focused over a second gel and preferably then separated in a third gel.

In a preferred embodiment, the second and third gels are SDS-PAGE gels and/or IPG gels.

In yet another embodiment, a reducing agent such as, but not limited to thiol reductants such as dithiothreitol (DTT) is included in a sample solution to be electrophoresed. During electrophoresis, the DTT partially dissolves the IPG matrix, thus creating a more macroporous gel matrix that allows the absorption and focusing of macromolecules of high molecular weight, for example equal to and greater than about 200 kDa.

In one embodiment, the method further comprises pre-fractionation and subsequent concentration of specific subsection (according to pl) of macromolecules within a complex mixture.

In one embodiment, the method of the second aspect further comprises transferring the IPG gel to a second gel and at least partially solubilising the IPG gel to release a macromolecule to the second gel. Preferably, the method further comprises performing electrophoresis on the second gel.

In an alternate embodiment, the method further comprises excising a fraction containing a macromolecule from the IPG gel. Preferably, the excised fraction is solubilised to release a macromolecule contained therein.

In a third aspect, the present invention provides use of the IPG gel of the invention as described herein to separate and analyse a macromolecule in a sample.

In a fourth aspect of the invention, the present invention is directed to a gel for use in electrophoresis, the gel comprising a polymerised mixture of substituted or unsubstituted acrylamide, acryloyl amino ethoxy ethanol (AAEE), or acryloyl amino propanol (AAP), (II) BAC (CH₂═CHCONHCH₂CH₂S)₂, and optionally (III) a non-reducible crosslinker and/or (IV) agarose;

wherein the gel comprises a single percent T or polyacrylamide gradient.

In a further preferred embodiment the gel comprises a non-reducible crosslinker, such as PDA or N,N methylene bis-acrylamide.

Preferably, the gel comprises about 2% to about 10% C, more preferably about 3% to about 6% C more preferably about 4% to about 5% C, most preferably about 4% C.

Preferably, the gel comprises a polyacrylamide gradient of about 0 to about 30% T, more preferably about 0 to about 25% T, more preferably about 0 to about 20% T, preferably about 0 to about 15% T, preferably about 0 to about 10% T, preferably about 0 to about 7.5% T. Alternatively, the gel comprises a polyacrylamide gradient of about 2 to about 14% T, more preferably about 3 to about 10% T, more preferably about 3 to about 8% T, alternatively about 4 to about 12% T, or alternatively about 5 to about 15% T, more preferably about 7 to about 15% T.

In one preferred embodiment, the gel comprises 4% C, and an acrylamide gradient of 0-1 2% T.

In one embodiment the gel is an SDS-PAGE gel.

In one embodiment, the gel comprises a mixture of polymerized monomeric units of (I) acrylamide (CH₂═CH—CO—NH₂) and (II) BAC (CH₂═CHCONHCH₂CH₂S—)₂, (IV) agarose and optionally (III) non-reducible crosslinker.

The gel may comprise a uniform concentration of about 0.1% to about 1% agarose.

In an alternate embodiment, the gel comprises an agarose gradient of about 0 to about 1% agarose. Preferably, the gel comprises an agarose gradient of about 0 to about 0.5%, about 0.5 to about 1%, about 1 to about 0.5% or about 0.5 to about 0% agarose.

Preferably, the gel comprises about 0 to about 8% T, when used in combination with agarose.

In another embodiment, the gel comprises a mixture of polymerized monomeric units of (I) acrylamide (CH₂═CH—CO—NH₂), (II) BAC (CH₂═CHCONHCH₂CH₂S)₂, and (III) non-reducible crosslinker. Preferably, unit (III) is PDA (C₁₀H₁₄N₂O₂).

In a fifth aspect, the present invention provides use of the gel of the invention for separating or analysing a macromolecule in a sample.

Preferably, the macromolecule has a molecular weight of about 15 kDa to about 750 kDa

In a sixth aspect, the present invention provides a method for separating or analysing macromolecules in a sample, the method comprising:

(i) treating the sample to alkylate existing free protein thiols or reduce and alkylate protein cystine/cysteines in the sample;

(ii) performing electrophoresis on the treated sample using the gel of the fourth aspect of the invention.

In one embodiment of the sixth aspect of the invention, the SDS-PAGE gel is solubilised or partially solubilised and a macromolecule recovered or subjected to further separation steps.

The sample containing the macromolecules may be selected from the group consisting of tissue samples, glandular secretions, plasma samples, cell samples, microorganisms, or culture samples. Preferred examples of samples include but are not limited to E. coli, plasma and saliva.

In a preferred embodiment the method of the present invention further comprises transferring the gel from step (ii) to a second gel. Preferably, the method further comprises at least partially solubilising the gel from step (ii) to release the macromolecules to the second gel. Preferably, the method comprises performing electrophoresis on the second gel.

The second gel may be an IPG gel, polyacrylamide gel or an SDS-polyacrylamide gel.

The method of sixth aspect of the invention may be repeated two or more times to improve separation.

In one embodiment, the method includes dissolving the gel using reducing agents such as, but not limited to thiol reductants such as DTT and β-mercapto-ethanol, either before or after digestion with trypsin, yet before extraction for MALDI-TOF-MS analysis.

In another embodiment, the method includes dissolving gel matrix away during transfer to a Membrane support during Western blotting procedures.

In yet another embodiment, prior to (i) the macromolecules in the sample are subjected to a separation procedure, preferably comprising pre-fractionation and subsequent concentration of specific sub-section (according to pl) of macromolecules within a complex mixture.

In a further preferred embodiment, the gel partially comprises a non-reducible crosslinker, such as PDA or N,N methylene bis-acrylamide, and the gel is partially solubilised.

In a seventh aspect the present invention provides a polymer gel comprising a polymerised mixture comprising (I) CH₂═CR₁—CO—NR₂R₃, (II) (CH₂═CHCONHCH₂CH₂S—)₂ (BAC) and (III) a non-reducible crosslinker, wherein R₁, R₂, and R₃ are the same or different and are hydrogen or optionally substituted alkyl or cycloakyl, the gel being such that it retains a gel structure when the disulphide bonds of the BAC derived units are cleaved.

In a further aspect the invention provides a polymer gel comprising a polymerised mixture of monomers comprising (I) CH₂═CR₁—CO—NR₂R₃, (II) (CH₂═CHCONHCH₂CH₂S—)₂ (BAC) and (III) piperazine di-acrylamide (PDA), wherein R₁, R₂, and R₃ are the same or different and are hydrogen or optionally substituted alkyl or cycloakyl.

In yet a further aspect the invention provides a polymer gel comprising a polymerised mixture of monomers comprising (I) CH₂═CR₁—CO—NR₂R₃, (II) (CH₂═CHCONHCH₂CH₂S—)₂ (BAC) and (III) a non-reducible crosslinker, wherein R₁, R₂, and R₃ are the same or different and are hydrogen or optionally substituted alkyl or cycloakyl, wherein at least a portion of the disulphide bonds of the polymerised mixture have been cleaved. Preferably, the disulphide bonds are cleaved. Preferably, wherein the disulphide bonds have been cleaved by addition of a reducing agent to the polymer mixture. Preferably, the reducing agent is a thiol reductant.

In one embodiment, the polymer gel is in the form of an electrophoresis gel. Preferably, the disulphide bonds are cleaved by a reducing agent contained in a sample electrophoresed through the gel.

In another aspect the invention provides a method of controlling the porosity of a polymer gel comprising a polymerised mixture of monomers comprising (I) CH₂═CR₁—CO—NR₂R₃, (II) (CH₂═CHCONHCH₂CH₂S—)₂ (BAC) and (III) a non-reducible crosslinker, wherein R₁, R₂, and R₃ are the same or different and are hydrogen or optionally substituted alkyl or cycloalkyl, the method comprising treating the polymer gel to cleave at least a portion of the disulphide bonds of the BAC. Preferably, all the disulphide bonds are cleaved. Preferably, the polymer gel is an electrophoresis gel. In one embodiment, the disulphide bonds are cleaved prior to using the gel to perform electrophoresis on a sample. Preferably, the disulphide bonds are cleaved by the inclusion of a reducing agent in a sample to be subjected to electrophoresis in the gel. In one embodiment, the reducing agent is a thiol.

It is to be understood that the methods as described may be combined with conventional methods of separation to achieve improved separation and analysis. In one embodiment, the method as described in the sixth aspect can be used in Western blotting such that the gel is solubilised during the procedure to achieve total protein binding from the gel matrix onto support membrane. Preferably, solubilising the gel during Western blotting procedures would yield 2D array blots of increased informative power due to more efficient transfer of proteins from the gel matrix to the supporting membrane of choice.

In another embodiment, the methods as described are combined with MALDI-MS analysis whereby gel matrix is dissolved before or after trypsin digestion to achieve enhanced peptide recovery. Preferably, gels of polyacrylamide ranging from 7-15% T yield similar resolving ranges to commercially prepared 4-12% T Bis cross-linked counterparts. Gels according to the invention have been analysed by MALDi-MS and showed that the gel system outlined herein produces similar signal intensities as the commercial counterpart, and, gave a profile showing the presence of a differentially released peptide fragment.

As will be recognised by those skilled in this field, the present invention enables the production of “all in one” type 2D separation systems. For example, two gels in which at least one is a dissolvable gel may be interfaced. Such an arrangement of gels will clearly be advantageous in 2D separation techniques.

### BRIEF DESCRIPTION OF THE FIGURES

FIG. 1 is a copy of a photographic representation of 2D arrays using 100% BAC and a 50% BAC (50% PDA) cross-linked IPGs (4% T) having a pH gradient of 4-7, wherein 3 mg/ml E. coli in ProteoPrep Kit is focused for 130 kVh. These were subsequently transferred onto a 6-15% GelChip second dimension gel and stained with Coomassie G-250.

FIG. 2 is a copy of a photographic representation of the 50% BAC pH 4-7 focused with 3 mg/ml plasma. Panels A+B depict the resulting 2D array when run without the presence of reducing agent such as DTT. Panels C+D however, depict the increased transfer of proteins out of the IPG when treated with reducing agent.

FIG. 3 is a copy of a photographic representation of slab gels using pH 4-7 BAC-IPG (i) and PDA-BAC-IPG (ii) before extraction (Panel A), and after bands have been removed (panel B). The sample used was 2 mg/ml E. coli and the focused slab has been stained with Coomassie G-250 for protein visualization. Zones neighbouring the extracted bands were also removed for extraction.

FIG. 4 is a copy of a photographic representation of 2D arrays of protein bands/zones extracted from BAC-IPG and PDA-BAC-IPG of FIG. 3 after re-focusing on pH 4-7 commercial IPG's. Panel A+B shows the refocusing of band 2 from the slabs whereas Panels C+D represent the refocused zone 1.

FIG. 5 is a copy of a photographic representation of refined 3 pH unit gradients formed using 100% BAC cross-linking. Panel A shows the pH 3-6 IPG using a pH 3-5.5 MCE fraction of plasma, Panel B shows a pH 5.5-6.5 fraction of plasma on a pH 5-8 BAC-IPG. Panel C demonstrates pH 7-10 BAC-IPG using a pH 7-10 MCE fraction of plasma.

FIG. 6 is a copy of a photographic representation of E. coli 2D arrays when run on a 10% Uniform gel using either PDA (Panel A) or BAC (Panel B) as the cross-linker. Note that the 40% T/2.5% C stock for each had a formamide base. The slight blurring of the spots in the low MWt area of the gel is believed to be a result of the breakdown of formamide. It is postulated that such effects could easily be eliminated through the pre-running of the gel.

FIG. 7 is a copy of a photographic representation of the blots produced when transferring such 2D arrays as shown in FIG. 6. Panel A+B shows a 50% BAC cross-linked 10% uniform gel without (A) and in the presence of β-ME (B). For control purposes, Panel C depicts a PDA only cross-linked gel in the presence of β-ME.

### ABBREVIATIONS

10% APS 10% w/v ammonium persulphate

20% T/4% C Polyacryalmide solution containing 20% total monomer of which 4% is from cross-linking monomer.

Agarose Agarose is a linear polysaccharide (average molecular mass about 12,000) made up of the basic repeat unit agarobiose, which comprises alternating units of galactose and 3,6-anhydrogalactose.

ASB-14 Amido Sulfo Betaine

BAC N,N′-bis(acryloyl)-cystamine

Bis-acrylamide N,N methylene bis-acrylamide

β-ME Beta-Mercapto Ethanol

DTT Dithiothreitol

FA Formic acid

Gel Buffer 375 mM Tris/HCl buffer pH 8.8

IAA Iodoacetamide

IEF Isoelectric focussing

IPG Immobilised pH Gradient

MALDI-MS Matrix assisted laser de-ionisation mass spectroscopy

MeCN Acetonitrile

MilliQ Milli Q water at 18.2 mega-ohms

MOPS running buffer=50 mM MOPS, 50 mM Tris, 1 mM EDTA, and 3.5

mM SDS

MOPS 3(N-Morpholino) propane sulfonic acid

PAS stain Periodic acid/Schiff's reagent stain for carbohydrates

PDA Piperazine di-acrylamide

SDS-PAGESodium dodecyl sulphate polyacrylamide gel electrophoresis

Sigma Kit C Solution 3=7M Urea, 2M Thiourea, 40 mM Tris, and 1% ASB-14

TBP Tri-butyl phosphine

TEMED N,N,N′,N′ tetramethylethylenediamine

TFA Tri-fluoro acetic acid

Tris Tris (hydroxymethyl) methylamine

Tris/HCl Tris base solution adjusted to required pH using hydrochloric acid

% T acrylamide (g)+grams crosslinker (g)/total volume

% C crosslinker (g)/acrylamide (g)+crosslinker (g)

In order that the nature of the present invention may be more clearly understood preferred forms thereof will now be described by reference to the following non-limiting Examples.

### Materials

Acrylamide(non-stabilised) (BDH) Prod #4429940

Acrylamido Buffer Powders (Fluka)

pK 3.1 Cat #01713

pK 3.6 Cat #01715

pK 4.6 Cat #01717

pK 6.2 Cat #01719

pK 7.0 Cat #01727

pK 8.5 Cat #01735 (This is supplied as 1 g stabilized with 0.1% hydroquinone and is a liquid)

pK 9.3 Cat #01738 (Supplied only as 200 mM solution in Isopropanol)

pK 10.3 Cat #01739 (This is supplied as 1 g stabilized with 0.1% hydroquinone and is a liquid)

Amino-n-Caproic acid (Sigma) Cat #A-2504

APS (BioRad) Cat #161-0700

ASB-14 Sydney Organic Synthesis Unit

β-ME (Sigma) Cat #M6250

Direct Blue 71 (Aldrich) Cat #21,240-7

E. coli (K-12 Strain) (Sigma) Cat #EC-1

Formamide (Sigma) Cat #F-5786

GelBond PAG film (Amersham) Cat #80-1129-37

Immobilon-PSQ (Millipore) Cat #ISEQ00010

MOPS (Sigma) Cat #M-1254

N, N′-bis(Acryloyl)-cystamine (Sigma) Cat #A-5912

N,N methylene bisacrylamide (BioRad) Cat #161-0200

6-15% linear gradient GelChip (Proteome Systems Ltd.)

GelChip Running Buffer (Tris/Tricine/SDS) (Proteome Systems Ltd.)

ProteoPrep Kit (Proteome Systems Ltd.) Cat #ProtTot

PDA (BioRad) Cat #: 161-0202

SDS (Sigma) Cat #L-3771

TEMED (Sigma) Cat #T-9281

Tris (BDH) Prod #103157P

### Equipment

BioRad power supply (BioRad)

Proteome Systems 570-90 Power Supply

Proteome Systems: Second Dimension Running tank

Immobiline Drystrip Kit (Pharmacia)

Branson Digital Sonifier Model 450

Transsonic T 700/H ultra-sonic water bath (John Morris Scientific)

### Computer Programs

Dr pH (copyright 1993 Hoefer Scientific Instruments)

### EXAMPLE 1

### Acrylamide/BAC Solution (40% T/2.5% C)

39 g Acrylamide

1 g BAC

Powders added to 80 ml formamide and heated to 60° C. to assist dissolution of BAC. Once dissolved, volume adjusted to 100 ml using formamide and the solution allowed to cool to room temperature. The 40% T/2.5% C solution was stored at room temperature in a foil-covered bottle.

Acrylamido Buffer Stock Solutions (200 mM in Formamide):

200 mM stock solutions of all Acrylamido Buffers were prepared by dissolving the appropriate Acrylamido Buffer powder using 100% formamide. Since the molecular mass of all the acrylamido buffers are different, 5 ml solutions of each were prepared to give a final concentration of 200 mM.

Weights used to produce 5 mls:

pK 3.1 MWt=163 Da Weight dissolved in 5 mls=163 mg

pK 3.6 MWt=129 Da Weight dissolved in 5 mls=129 mg

pK 4.6 MWt=157 Da Weight dissolved in 5 mls=157 mg

pK 6.2 MWt=190 Da Weight dissolved in 5 mls=190 mg

pK 7.0 MWt=200 Da Weight dissolved in 5 mls=200 mg

pK 8.5 MWt=142 Da Volume diluted to 5 mls=142 μl

pK 10.3 MWt=184 Da Volume diluted to 5 mls=184 μl

Since the pK 9.3 Acrylamido buffer can only be obtained as a 200 mM solution in Isopropanol, to prepare a 200 mM stock solution using formamide as the solvent, the Isopropanol is evaporated off using a speedy vac until only a small amount of residual solution is remaining. This is then re-diluted to its original volume using 100% formamide. Generally, 3 mls of solution is dried down (leaving ˜50-100 μl residual) before resuspending back to 3 ml as described.

### EXAMPLE 2

### BAC-IPG

A 4% T BAC-IPG (0.5 mm, 11 cm long) slab gel from which individual strips were excised, was poured after having calculated the Immobiline mix required to generate the pH range of interest using the Dr pH program (refer Appendix B for gradients used and their mixes). The pK in water of the Acrylamido buffers was entered into the Dr pH program to calculate the gradient make-up. Alternatively, the pK in Urea for each of the Acrylamido buffers could also be used, which would result in changes to the volumes required of each of the Acrylamido buffers to form the same pH gradient. The make-up of the most regularly used pH 4-7 gradient is as follows:

| Acidic Solution (pH 4.0) | | Basic Solution (pH 7.0) | |
|---|---|---|---|
| Immobiline pH 3.1 | 257.2 μl | Immobiline pH 4.6 | 271.6 μl |
| Immobiline pH 4.6 | 254.2 μl | Immobiline pH 6.2 | 244.1 μl |
| Immobiline pH 6.2 | 288.5 μl | Immobiline pH 7.0 | 102.2 μl |
| 1M Tris | 62.9 μl | Immobiline pH 8.5 | 182.1 μl |
| 40% T/2.5% C | 800 μl | 40% T/2.5% C | 800 μl |
| 50% Glycerol | 0 μl | 50% Glycerol | 1600 μl |
| MilliQ water | 6337 μl | MilliQ water | 2364 μl |

| | | | |
|---|---|---|---|
| Catalysts: | TEMED | 16 μl/8 ml gel solution | (0.1% final) |
| | 20% APS | 40 μl/8 ml gel solution | (0.2% final) |

Once catalysts are added to the gel solutions, the solutions are placed in the gradient former and the valves opened. A pump rate of 60 ml/min was used to pour the IPG after which the gel was over-laid with water-saturated iso-butanol and allowed to polymerise at 50° C. for 60 minutes.

The butanol was rinsed off before dismantling the glass plate sandwich and washing the gel in:

| | |
|---|---|
| 2 × 10% Methanol | 15 minutes each |
| 2 × 20% Methanol | 15 minutes each |

with the final 20% Methanol wash containing 5% glycerol

The IPG was then clamped to a glass plate support and dried over-night in a chemical fume cupboard. Once fully dehydrated, the IPG was covered with Glad Wrap and stored at −20° C.

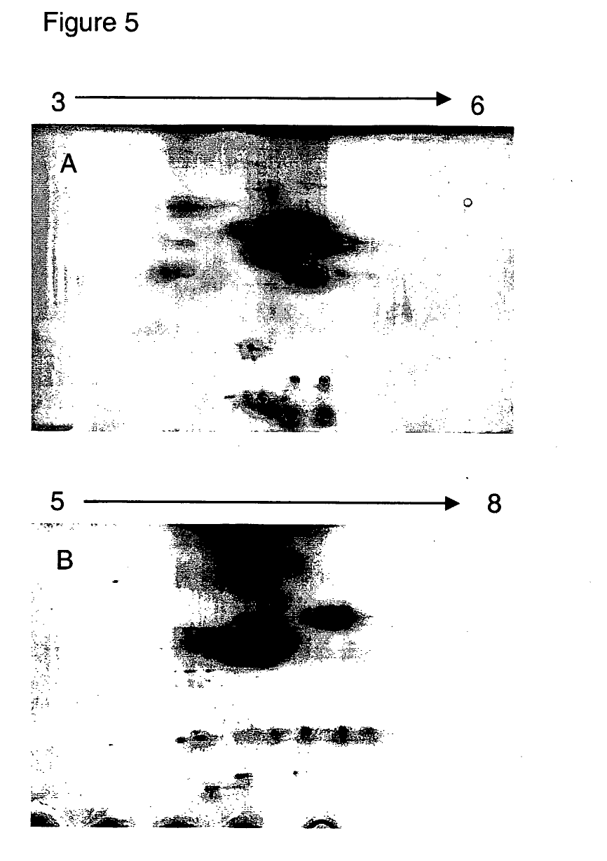

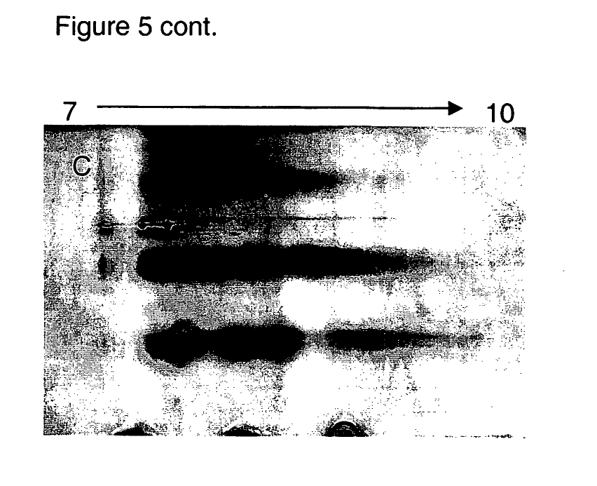

### EXAMPLE 3 (see FIG. 5)

### Refined 3 Unit pH IPG Gradients

pH 3-6

| Acidic Solution (pH 3.0) | | Basic Solution (pH 6.0) | |
|---|---|---|---|
| Immobiline pH 3.6 | 187.5 μl | Immobiline pH 3.6 | 33 μl |
| Immobiline pH 4.6 | 196 μl | Immobiline pH 4.6 | 322 μl |
| Immobiline pH 6.2 | 5 μl | Immobiline pH 6.2 | 309 μl |
| 1M Tris | 75 μl | Immobiline pH 9.3 | 137 μl |
| 40% T/2.5% C (BAC) | 800 μl | 1M Tris | 1 μl |
| 50% Glycerol | 0 μl | 40% T/2.5% C (BAC) | 800 μl |
| MilliQ water | 6736 μl | 50% Glycerol | 1600 μl |
| | | MilliQ water | 6337 μl |

pH 5-8

| Acidic Solution (pH 5.0) | | Basic Solution (pH 8.0) | |
|---|---|---|---|
| Immobiline pH 3.1 | 163 μl | Immobiline pH 4.6 | 220 μl |
| Immobiline pH 4.6 | 262 μl | Immobiline pH 6.2 | 46 μl |
| Immobiline pH 6.2 | 344 μl | Immobiline pH 7.0 | 303 μl |
| Immobiline pH 7.0 | 31 μl | Immobiline pH 8.5 | 195 μl |
| 1M Tris | 162 μl | Immobiline pH 9.3 | 36 μl |
| 40% T/2.5% C | 800 μl | 1M Acetic acid | 66 μl |
| 50% Glycerol | 0 μl | 40% T/2.5% C | 800 μl |
| MilliQ water | 6238 μl | 50% Glycerol | 1600 μl |
| | | MilliQ water | 4733 μl |

pH 7-10

| Acidic Solution (pH 7.0) | | Basic Solution (pH 10.0) | |
|---|---|---|---|
| Immobiline pH 4.6 | 315 μl | Immobiline pH 4.6 | 38 μl |
| Immobiline pH 6.2 | 366 μl | Immobiline pH 7.0 | 333 μl |
| Immobiline pH 7.0 | 119 μl | Immobiline pH 8.5 | 235 μl |
| 1M Acetic acid | 31 μl | Immobiline pH 9.3 | 194 μl |
| 40% T/2.5% C | 800 μl | 1M Acetic acid | 142 μl |
| 50% Glycerol | 0 μl | 40% T/2.5% C | 800 μl |
| MilliQ water | 6369 μl | 50% Glycerol | 1600 μl |
| | | MilliQ water | 4658 μl |

All IPG gels were polymerised using the following amounts of the two catalysts:

| | | |
|---|---|---|
| TEMED | 16 μl/8 ml gel solution | (0.1% final) |
| 20% APS | 40 μl/8 ml gel solution | (0.2% final) |

### EXAMPLE 4

### Same Preparation for IEF

90 mg E. coli K-12 Strain (lyophilised) (Sigma, EC-1) was re-suspended in 15 ml of ProteoPrep Kit (7M Urea, 2M Thiourea, 40 mM Tris, and 1% C7) giving a final concentration of 6 mg/ml. The suspension was then sonicated for 6×10 second bursts at 70% amplitude with cooling on ice between bursts for 1-2 minutes to minimize carbamylation of proteins.

The lysate was reduced using 5 mM TBP for 1 hour at room temperature before fully alkylating the sample with 15 mM IAA for 1 hour in the dark at room temperature. Cell debris was separated from solubilised proteins by microfuging at 21000 g for 10 minutes before aliquoting and storing at −20° C.

For use in the BAC-IPG system, the 6 mg/ml E. coli lysate was further diluted to 3 mg/ml final using ProteoPrep Kit before adding a trace of 1% Orange G as tracking dye. Generally, 220 μl was used to rehydrate a 3 mm wide strip from the 11 cm IPG slab, or a proportionate volume for 2-3 cm wide slabs also investigated. Rehydration was complete in 6-8 hrs at room temperature.

### Plasma

Whole blood was collected and processed using commonly defined methodology to yield plasma samples which were stored at −20° C. Additional treatments then applied to a plasma sample for use on 2D electrophoresis is outlined below.

Acetone precipitation was performed to effectively desalt the sample through precipitation of proteins from the biological fluid, Basically, CHAPS was added to 1 ml of plasma to a final concentration of 0.5%. The plasma/CHAPS was then diluted to 10 ml with acetone pre-chilled to −20° C., and precipitation performed at −20° C. for 30 minutes. Precipitate was collected by centrifugation at 5000×g and 4° C., before resuspending in 10 ml of 7M Urea, 2M Thiourea, 40 mM Tris, and 2% CHAPS by probe sonification at an amplitude of 70% for 3×15 seconds, with cooling on ice between sonic bursts.

Following desalting of plasma proteins, the sample was then reduced and alkylated. Standard reduction was done using 5 mM TBP for one hour at room temperature after which the sample was alkylated with 15 mM IAA for one hour at room temperature in the dark. The sample was then aliquoted and stored at −20° C.

Plasma samples were then used at 100% concentration or diluted to lower levels when necessary using sample solution alone.

### Saliva

Saliva (10 ml) was collected on ice before adding 10 mM DTT and leaving to stand for 20 mins before microfuging in 2 ml aliquots at 21,000×g for 10 minutes. 1 ml was then removed from the middle of the resulting supernatant as to avoid the pelleted material and lipids separated on the surface.

The resulting 5 ml of spun saliva was then used to solubilise the components of the sample solution outlined below.

Saliva Sample (Saliva in 7M Urea, 2M Thiourea, 40 mM Tris,
and 1% CHAPS)

| | |
|---|---|
| 2.1 g | Urea |
| 761 mg | Thiourea |
| 24.2 mg | Tris |
| 50 mg | CHAPS |

Made up to 5 ml with spun saliva. Place on rocker to dissolve. Note: the sample should not be sonicated at any stage so as to maintain integrity of mucins and the like present in the saliva.

Saliva sample was then alkylated with 15 mM IAA for one hour in the dark at room temperature. The saliva sample was then aliquoted and stored at −20° C.

Saliva samples were then used directly to rehydrate IPG strips without further dilution. In some instances, up to 0.1M DTT was added to the sample as a powder, to dissolve the BAC cross-links within the matrix during the rehydration phase. It is postulated by the inventors, that this will allow easier entry of high molecular weight components within samples. Active rehydration may also be applied to assist this process.

### EXAMPLE 5

### BAC-IPG

For the first dimension using BAC-IPG's and Pharmacia pH 4-7 Immobiline Drystrip 11 cm IPG's as controls:

Running Parameters

Focus over a gradient of: (50 μA/strip limit)

300 V rapid ramp over 4 hours

10000 V linear ramp over 6 hours

10000 V rapid ramp for 6-10 hours

Focused strips were then used for band extraction, or equilibrated and run on a second dimension gel, or stored by sealing in an air tight container and placing at −20° C.

### EXAMPLE 6

### Band Extraction

Focused BAG-IPG and PDA-BAC-IPG slabs of E. coli, which had been stained in Coomassie Brilliant Blue G-250 (0.1% G-250, 17% ammonium sulfate, 34% methanol, and 3% ortho-phosphoric acid) for 6 hrs to O/N, before de-staining in 1% acetic acid were used for band extraction experiments.

Using a light box to assist band visualization, bands were selected and removed by firstly cutting along each side of the band using a clean scalpel blade. A modified yellow tip (refer Appendix A) was then used to collect the band, which was transferred to an eppendorf containing 500 μl ProteoPrep Kit containing 50 μl β-ME. The band was then sonicated in a sonic water bath for up to 10 minutes or until full dissolution of the band was achieved (care taken not to heat the solution so as to minimize carbamylation).

The dissolved band can then be used to directly rehydrate a new IPG strip for a second round of iso-electric focusing or stored at −20° C. for later use.

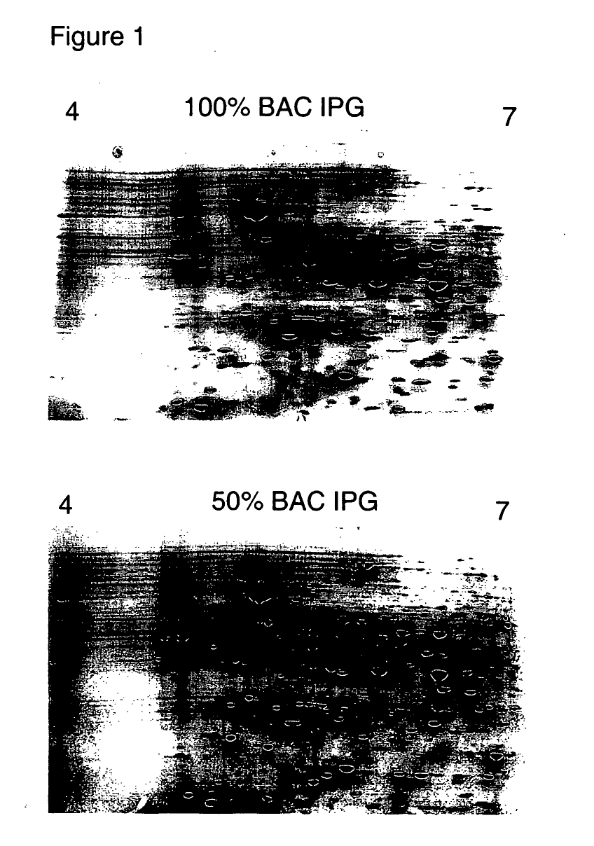

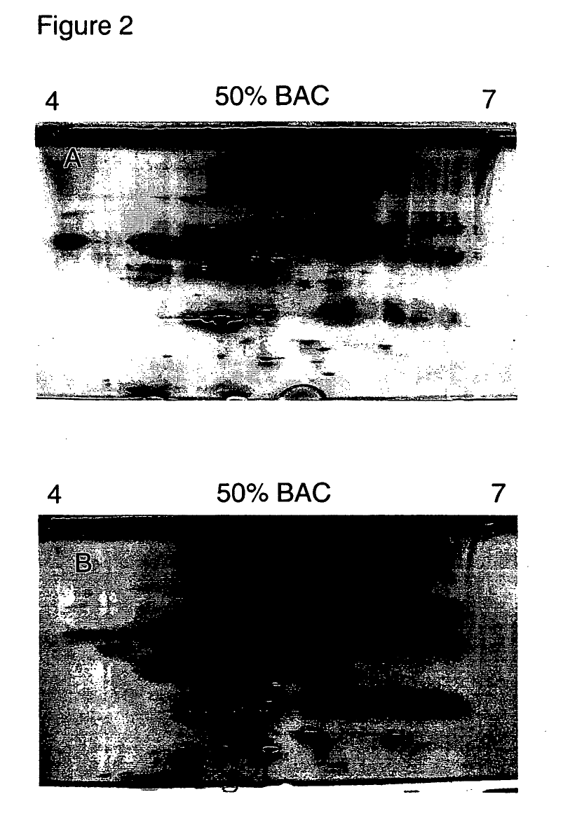

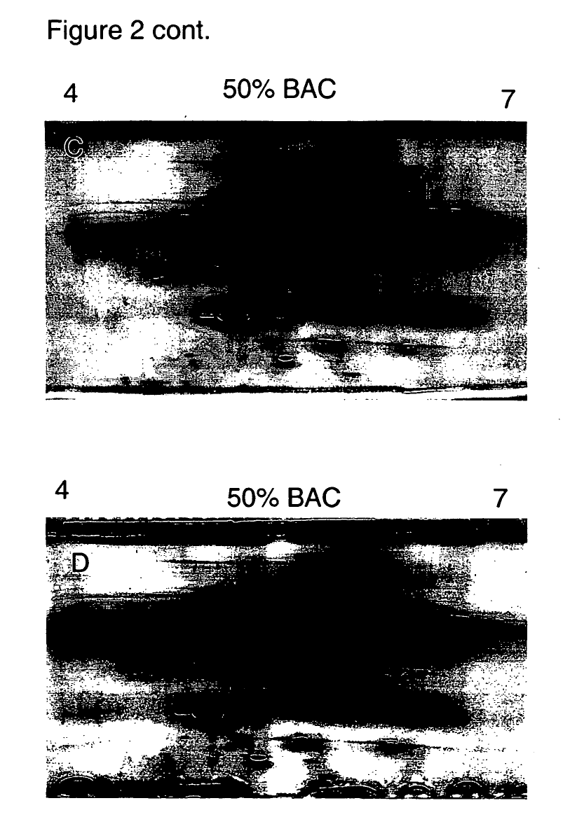

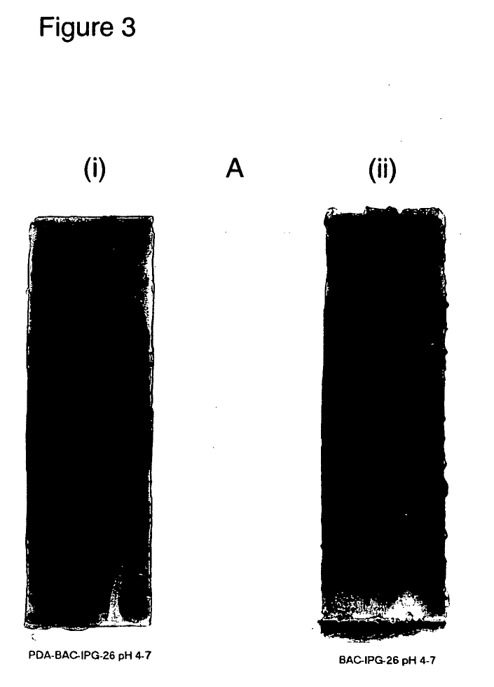

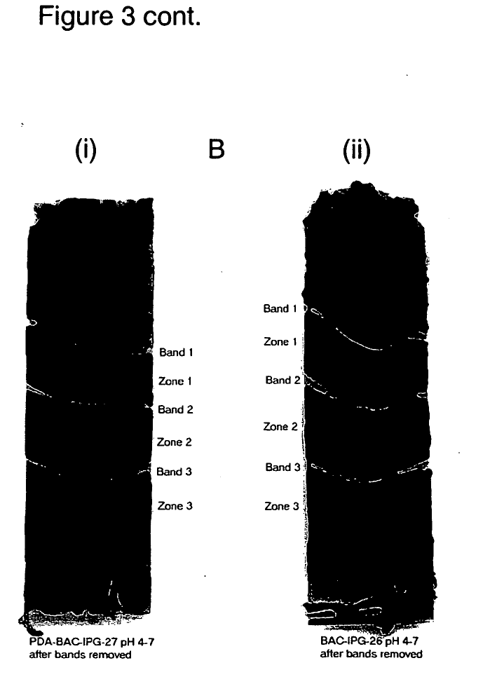

An example of a BAC-IPG and PDA-BAC-IPG stained slab of E. coli proteins before band extraction can be seen in FIG. 3. An example of the 2D arrays from the BAC-IPG and PDA-BAC-IPG slabs depicted in FIG. 3 are demonstrated in FIG. 1.

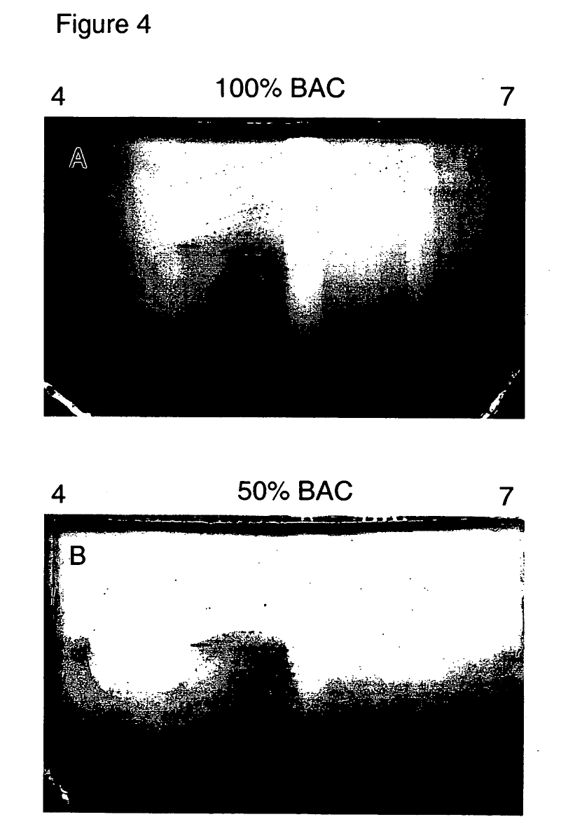

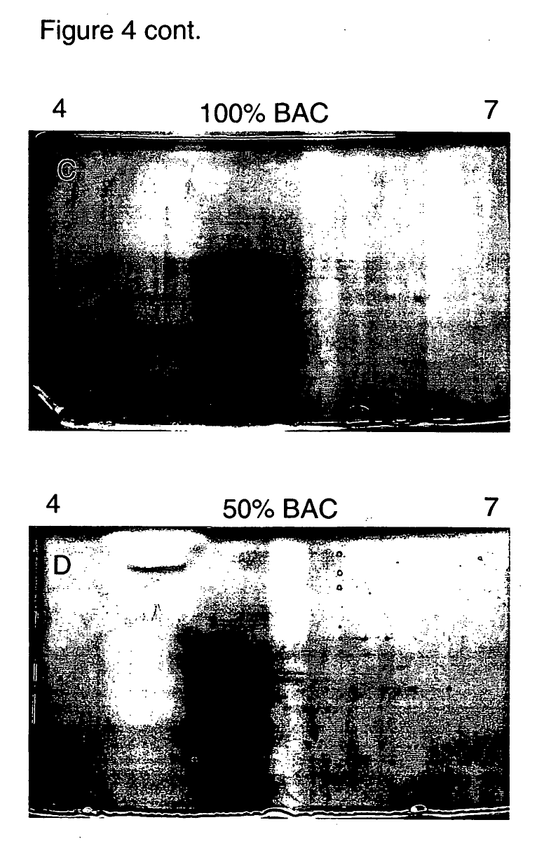

FIG. 4 shows resulting 2D arrays from re-focused extracted bands (panels A+B) and extracted zones (Panels C+D) at a 1× re-loading of a 3 mm IPG strip from each of the BAC-IPG and PDA-BAC-IPG slabs.

### EXAMPLE 7

### Enhanced Transfer of Proteins to the Second Dimension Gel

The formulation for producing an IPG gel having a pH 3-10 gradient is outlined. The major structural change made for this aspect is the combination of reducible and non-reducible cross-linkers to yield a less retentive IPG matrix. This example is a PDA-BAC hybrid gel.

| Acidic Solution (pH 3.0) | | Basic Solution (pH 10.0) | |
|---|---|---|---|
| Immobiline pH 3.1 | 66.2 μl | Immobiline pH 4.6 | 19.2 μl |
| Immobiline pH 4.6 | 364.4 μl | Immobiline pH 6.2 | 443.0 μl |
| 1M Tris | 84.6 μl | Immobiline pH 7.0 | 144.6 μl |
| 40% T/2.5% C (PDA) | 400 μl | Immobiline pH 8.5 | 74.6 μl |
| 40% T/2.5% C (BAC) | 400 μl | Immobiline pH 9.3 | 118.5 μl |
| 50% Glycerol | 0 μl | 1M Acetic acid | 122.1 μl |
| MilliQ water | 6684.8 μl | 40% T/2.5% C (PDA) | 400 μl |
| | | 40% T/2.5% C (BAC) | 400 μl |
| | | 50% Glycerol | 1600 μl |
| | | MilliQ water | 6337 μl |

| | | | |
|---|---|---|---|
| Catalysts: | TEMED | 16 μl/8 ml gel solution | (0.1% final) |
| | 20% APS | 40 μl/8 ml gel solution | (0.2% final) |

Gels were poured using a gradient former and pumped at a rate of 50-60 ml/min., polymerized for 2 hours at 50° C. before dehydrating as outlined above and stored at −20° C. until used.

Once samples were focused, strips were equilibrated for use in a SDS-PAGE based gel system in a solution of 6M Urea, 2% SDS, 112 mM Tris/Acetate pH 7.0 gel buffer for 20 minutes at room temperature with constant rocking.

### EXAMPLE 8

### Enhanced Protein Entry when Matrix is Dissolved During Rehydration

Gels were poured as depicted in Example 6 above.

During rehydration, DTT or β-ME is added to the sample solution. This effectively dissolves all BAC cross-links within the matrix, allowing for a greater porosity gel matrix to result. It is postulated by the inventors that this aspect should allow focusing of previously size excluded material.

After rehydrating with reducing agent, the PDA-BAC-IPG strips were focused as described above before equilibrating and running onto a SDS-PAGE second dimension gel.

### EXAMPLE 9

### SDS-PAGE-BAC Gels

The gels used had an acrylamide gradient of either 3-8%, 4-12% and 6-15% or were of uniform % T throughout such as 10% T and 15% T. To assist in the handling and to assist maintaining gel size during staining, the BAC containing gels were formed onto a GelBond backing sheet, though this isn't essential to their formation. The procedure for pouring all gels was the same with variations in the amount of acrylamide/BAC stock solution to water volume used for each % T gel.

### 4-12% T

For each GelChip size gel (8 cm×13.5 cm×1 mm), 12 mls of solution is required. Hence, for gradient gels, 6 mls of each solution is needed.

| | 4% | 12% |
|---|---|---|
| 40% T/2.5% C (BAC) | 0.6 ml | 1.8 ml |
| 1M Tris/Acetate buffer pH7 | 672 μl | 672 μl |
| 50% Glycerol | 0 | 2 ml |
| MilliQ | 4.73 ml | 1.53 ml |
| Total | 6 ml | 6 ml |
| Catalysts: | TEMED | 12 μl/6 ml (0.1%) |
| | 20% APS | 30 μl/6 ml (0.2%) |

For a 10% Uniform Gel,

| | 10% |
|---|---|
| 40% T/2.5% C (BAC) | 3 ml |
| 1M Tris/Acetate buffer pH7 | 1.344 ml |
| 50% Glycerol | 4 ml |
| MilliQ | 3.656 ml |

| | | |
|---|---|---|
| Catalysts: | TEMED | 24 μl/6 ml (0.1%) |
| | 20% APS | 60 μl/6 ml (0.2%) |

Gels were poured using 1.0 mm spacers, at room temperature and a pump rate of 60 ml/min before overlaying with butanol and polymerizing at 50° C. for one hour.

Butanol was rinsed off with MilliQ before overlaying the gels with 112 mM Tris/Acetate pH 7 buffer and storing at 4° C. sealed in plastic zip lock bags until used.

### EXAMPLE 10

### Sample Preparation for SDS-PAGE

Either molecular weight standards or focused pH 4-7 IPG's of E. coli lysate (3 mg/ml) were used as samples to investigate various % T gels in order to obtain a gel providing a resolution range in the order of 15-250+ kDa.

6-15% GelChip second dimension gels were used as the comparative control gel.

Molecular weight standards were reduced using 5 mM TBP for one hour and alkylated with 15 mM IAA for an hour in the dark prior to use on BAC based gels to over-come cysteine containing standards from interacting with the BAC moieties in the gel matrix. The molecular weight standards used were either BioRad's Broad Range mix or Kaleidoscope Pre-stained markers.

When focused IPG strips were to be used, the strips were firstly equilibrated in a solution containing 6M Urea, 50 mM Tris/Acetate pH 7, 2% SDS and a trace of Bromo-phenol Blue as tracking dye for 20 minutes before loading onto the GelChip control or acrylamide/BAC gels.

### EXAMPLE 11

### 1× GelChip Running Buffer

A 10× stock solution of Tris/Tricine/SDS buffer is prepared by dissolving a Running Buffer Pack (Proteome Systems Ltd.) using MilliQ. This is then diluted accordingly with MilliQ to yield a final 1× solution of 50 mM Tris/50 mM Tricine/2% SDS.

### EXAMPLE 12

### Running Parameters

The running conditions for the GelChip and BAC containing gels was a constant current of 50 mA/gel.

The run was stopped once the bromo-phenol blue front had just run from the bottom of the gel. The gel sandwich was then disassembled and the gels stainedin Coomassie Brilliant Blue G-250 over-night before de-staining in 1% acetic acid. FIG. 1 shows the 2D maps of E. coli (3 mg/ml) when separated on 10% SDS-PAGE-BAC gels.

### EXAMPLE 13

### Western Blotting of 2D arrays

10% uniform gels using PDA, PDA-BAC, or BAC cross-linking were used to generate pH 47 E. coli arrays that were subsequently transferred, to Immobilon-PSQ membrane with/without the presence of β-ME.

For transfer, a stack was constructed such that the top 2 pieces of blotting paper had been soaked in Solution 1 (25 mM Tris/40 mM amino-n-Caproic acid/0.01% SDS/10% methanol), followed by the gel which after a 2 min rinse in MilliQ, had been soaked in Solution 1 for 5 mins. This then sat on top of the membrane and next piece of blotting paper which were soaked in Solution 2 (25 mM Tris/20% methanol). This stack was then placed on top of a ion trap of blotting paper soaked in Solution 3 (300 mM Tris). Gels were transferred to membrane at 20 mA for 20 min then 400 mA for 30 min before staining in Direct Blue 71 for 10 min and washing in 40% methanol/10% acetic acid and air drying.

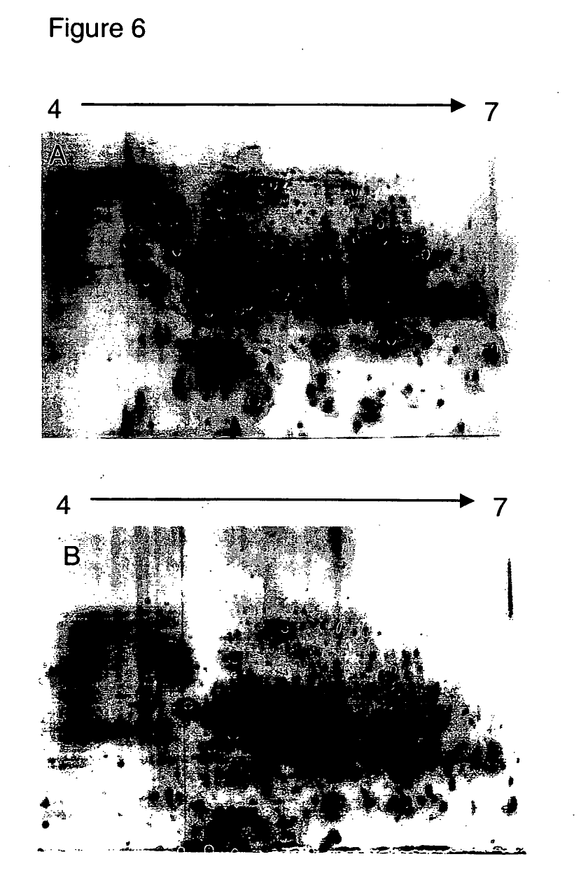

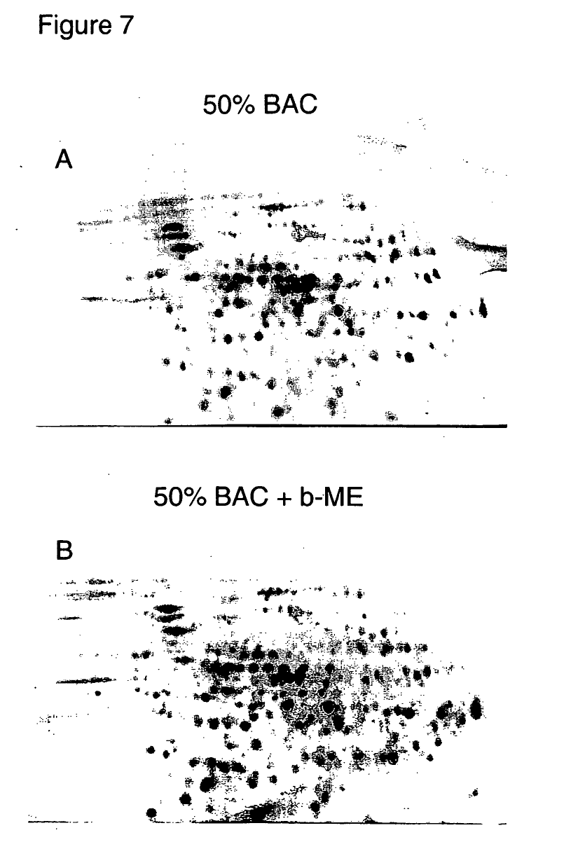

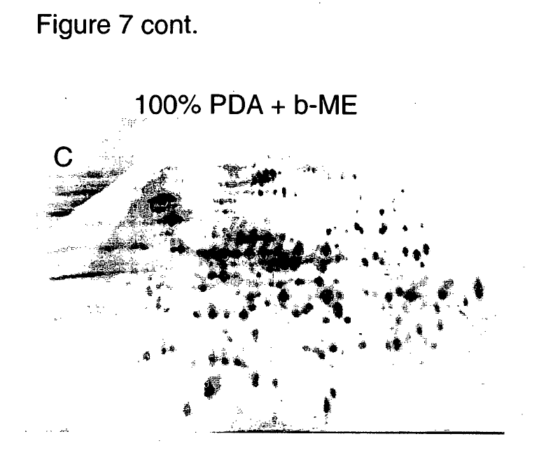

The resulting Direct Blue 71 stained blots are depicted in FIG. 6 which clearly shows that formamide and BAC containing gels still allow effective transfer from the gel matrix. The PDA only control blot shown in FIG. 6 had also been treated with β-ME.

### EXAMPLE 14

### Axima Mass Spectrometers (M006) Analysis

From the gels depicted in FIGS. 4, 5 and 6, protein spots were selected and excised from the gels for MS analysis (indicated by arrows on FIGS. 4 and 6). The spots selected were chosen on the basis of 2 properties: stain intensity, so as to test the extraction efficiency of peptides as well as any differential peptides released, and according to molecular weight, to assess the solubility properties of the % T range resolved.

The 2 sets of excised protein spots from the 7-15% SDS-PAGE-BAC gels were compared against the same spots from a Novex 4-12% B/T Zoom gel. One set of SDS-PAGE-BAC spots were treated identically to the Novex excised spots, whilst the other set of SDS-PAGE-BAC spots were dissolved in 20 μl 0.1 M DTT (after trypsin digestion) by sonicating with an Ultra-sonic probe for 2×1 second at 50% amplitude.

The general method for MALDI-MA analysis used was:

### Washing

150 μL of wash solution (50% v/v Acetonitrile (MeCN), 2.5 mM Tris-HCl, pH 8.5) was added to each gel piece. The plate was covered and put on the rocker for 1 hour to let the pieces destain. (The wash solution was taken off with care taken so as to not lose any gel pieces).

Sealing tape was again placed on the plate and holes were placed over every well containing a gel piece. The gel pieces were dried under vacuum for approximately 15 minutes.

### Digestion

10 μL of Trypsin (0.02 μg/μL trypsin in 2.5 mM Tris-HCl, pH 8.5) was added to each well containing a single gel piece, covered and digested at 30° C. overnight.

### Extraction

Extraction solution: 50% v/v MeCN

0.5% v/v Trifluoroacetic acid (TFA) (use fume hood)

10 μL extraction solution added to each well before sonicating for 10 minutes in the ultrasonic bath. 10 μL MQ was added to each well, the lid taken off before placing in the incubator for 10 minutes. This is to evaporate some of the acetonitrile.

The samples were then cleaned using Zip Tips before spotting onto the MALDI plate.

### EXAMPLE 15

### Zip Tip Sample Cleanup and Loading

Solutions required:—90% v/v MeCN, 5% v/v FA (a couple of 1 mL eppis)

70% v/v MeCN, 5% v/v FA for matrix(400 μL)

5% v/v FA (100 μL per eppi, one eppi per spot)

Matrix:—4 μg α-cyano-4-hydroxycinnamic acid in 400 μL

70% v/v MeCN, 5% v/v FA

Using a new Zip Tip/gel piece, draw up 1×90% v/v MeCN to wet/wash column, and 2×5% v/v FA to equilibrate column. The sample was bound to the column by passing the sample over the column 3 times.

The sample was washed using 3×0.1% v/v TFA before drawing up 1 μl matrix into Zip Tip and eluting the peptides onto the MALDI plate.

The spotted samples were then analyzed using a Axima-CFR mass spectrometer (Kratos analytical)

### References

Hansen, J. N. Analytical Biochemistry, 76, 37-44, (1976)

Hansen, J. N., Pheiffer, B. H., Boehnert, J. A. Analytical Biochemistry, 105, 192-201, (1980)

Hansen, J. N. Analytical Biochemistry, 116, 146-151, (1981)

BioRad Product information sheet on BAC

Laurell, C. B. J. Chromatography, 159, 25 (1978)

Flyer, D. C, Tevethia, S. S, Virology, 117, 267 (1982)

Bode, J, Schroter, H, Maass, K, J. Chromatography, 190, 437 (1980)

Srihari et al Basic Research in Cardiology, 77, 599 (1982)

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An immobilised pH gradient (IPG) gel comprising a polymerised mixture of monomers comprising (I) CH═CR₁—CO—NR₂R₃, (II) (CH₂═CHCONHCH₂CH₂S—)₂ (BAC) and optionally (III) a non-reducible crosslinker, wherein R₁, R₂, and R₃ are the same or different and are hydrogen or optionally substituted alkyl or cycloakyl.

2. The IPG gel according to claim 1, wherein the alkyl is C₁-C₄ alkyl.

3. The IPG gel according to claim 1, wherein at least one of R₁, R₂, and R₃ is C₁-C₄ alkyl.

4. The IPG gel according to claim 1, wherein the gel comprises 2% to 20% T.

5. The IPG gel according to claim 1, wherein the gel comprises 2% to 10% T,

6. The IPG gel according to claim 1, wherein the gel comprises 2% to 8% T,

7. The IPG gel according to claim 1, wherein the gel comprises 3% to 6% T,

8. The IPG gel according to claim 1, wherein the gel comprises 4% T.

9. The IPG gel according to claim 1 comprising 1% C to 8.5% C.

10. The IPG gel according to claim 1 comprising 2% C to 6% C.

11. The IPG gel according to claim 1 comprising 3% C to 5% C.

12. The IPG gel according to claim 1 comprising 4% C.

13. The IPG gel according to claim 1 comprising 4% T/2.5% C.

14. The IPG gel according to any one of the preceding claims, wherein the non-reducible cross-linking agent is absent.

15. The IPG gel according to any one of claims to 14, wherein the mixture of monomers comprises (I), (II) and (III).

16. The IPG gel according to claim 15, comprising a molar ratio of (II):(III) of 1:5 to 5:1.

17. The IPG gel according to claim 15 comprising a molar ratio of unit (II), unit (III) of 1:4 to 4:1.

18. The IPG gel according to claim 15 comprising a molar ratio of unit (II): unit (III) of 1:3 to 3:1.

19. The IPG gel according to claim 15 comprising a molar ratio of unit (II): unit (III) of 1:2 to 2:1.

20. The IPG gel according to claim 15 comprising a molar ratio of unit (II): unit (III) of 1:1.

21. The IPG gel according to claim 15, wherein unit (III) is PDA (C₁₀H₁₄N₂O₂) or N,N methylene bis-acrylamide.

22. An immobilised pH gradient (IPG) gel for use in electrophoresis, the gel comprising a mixture of polymerised monomeric units of acrylamide, BAC and PDA, wherein the gel comprises 4% T/2.5% C and a molar ratio of BAC:PDA of 1:1.

23. Use of the IPG gel according to claim 1 for analysing or separating at least one macromolecule in a sample.

24. A method of separating or analysing macromolecules in a sample comprising performing isoelectric focussing on a sample using an IPG gel according claim 1.

25. The method according to claim 24, comprising treating the sample to alkylate any protein thiol present in the sample or reduce and alkylate macromolecules in the sample.

26. The method according to claim 24, comprising transferring the IPG gel to a second gel and at least partially solubilising the IPG gel to release the macromolecules to the second gel.

27. The method according to claim 26, comprising performing electrophoresis on the second gel.

28. The method according to claim 26, wherein the second gel is a SDS-PAGE gel.

29. The method according to claim 26, wherein the second gel is an IPG gel.

30. The method according to claim 24, comprising staining the IPG gel to visualise the macromolecules contained therein.

31. The method according to claim 24 further comprising excising a fraction containing macromolecules from the IPG gel.

32. The method according to claim 31, comprising at least partially solubilising the excised fractions.

33. A gel for use in electrophoresis, the gel comprising a polymerized mixture of (I) substituted or unsubstituted acrylamide, acryloyl amino ethoxy ethanol (AAEE), acryloyl amino propanol (AAP), (II) BAC (CH₂═CHCONHCH₂CH₂S—)_{2,} and optionally (III) a non-reducible crosslinker and/or (IV) agarose;
wherein the gel comprises a single percent T or polyacrylamide gradient.

34. The gel according to claim 33, wherein the substituted acrylamide is dimethyl acrylamide.

35. The gel according to claim 33, wherein the gel comprises 2% C to 10% C.

36. The gel according to claim 33, wherein the gel comprises a polyacrylamide gradient of 0 to 30% T.

37. The gel according to claim 33, wherein the gel comprises a polyacrylamide gradient of 3 to 20% T.

38. The gel according to claim 33, wherein the gel comprises 4% C, and an acrylamide gradient of 0 to 7.5% T.

39. The gel according to claim 33, wherein the gel comprises a uniform concentration of 0.1% to 1% agarose.

40. The gel according to claim 33, wherein the gel comprises an agarose gradient of 0 to 1% agarose.

41. The gel according to claim 33, wherein the gel comprises a mixture of polymerized monomeric units of (I) acrylamide (CH₂═CH—CO—NH₂), (II) BAC (CH₂═CHCONHCH₂CH₂S—)_{2,}, and (III) non-reducible crosslinker.

42. The gel according to claim 41, wherein the non-reducible cross-linker (III) is PDA (C₁₀H₁₄N₂O₂).

43. The gel according to claim 33, wherein the gel is an SDS-PAGE gel.

44. Use of the gel according to claim 33 for separating or analysing a macromolecule in a sample.

45. Use of the gel according to claim 43 for separating or analysing a macromolecule in a sample.

46. A method for separating or analysing macromolecules in a sample, the method comprising:
i) treating the sample to alkylate existing free protein thiols or reduce and alkylate protein cystine/cysteines in the sample;
ii) performing electrophoresis on the treated sample using the gel of claim 33.

47. A polymer gel comprising a polymerised mixture comprising (I) CH₂═CR₁—CO—NR₂R₃, (II) (CH₂═CHCONHCH₂CH₂S—)₂ (BAC) and (III) a non-reducible crosslinker, wherein R₁, R₂, and R₃ are the same or different and are hydrogen or optionally substituted alkyl or cycloakyl, the gel being such that it retains a gel structure when the disulphide bonds of the BAC derived units are cleaved.

48. A polymer gel comprising a polymerised mixture of monomers comprising (I) CH₂═CR₁—CO—NR₂R₃, (II) (CH₂═CHCONHCH₂CH₂S—)₂ (BAC) and (III) piperazine di-acrylamide (PDA), wherein R₁, R₂, and R₃ are the same or different and are hydrogen or optionally substituted alkyl or cycloakyl.

49. A polymer gel comprising a polymerised mixture of monomers comprising (I) CH₂═CR₁—CO—NR₂R₃, (II) (CH₂═CHCONHCH₂CH₂S—)₂ (BAC) and (III) a non-reducible crosslinker, wherein R₁, R₂, and R₃ are the same or different and are hydrogen or optionally substituted alkyl or cycloakyl, wherein at least a portion of the disulphide bonds of the polymerised mixture have been cleaved.

50. The polymer gel of claim 49, wherein substantially all the disulphide bonds are cleaved.

51. The polymer gel according to claim 49, wherein the disulphide bonds have been cleaved by addition of a reducing agent to the polymer mixture.

52. The polymer gel according to claim 51, wherein the reducing agent is a thiol reductant.

53. The polymer gel according to claim 48 in the form of an electrophoresis gel.

54. The polymer gel of claim 53, wherein the disulphide bonds are cleaved by a reducing agent contained in a sample electrophoresed through the gel.

55. A method of controlling the porosity of a polymer gel comprising a polymerised mixture of monomers comprising (I) CH₂═CR₁—CO—NR₂R₃, (II) (CH₂═CHCONHCH₂CH₂S—)₂ (BAC) and (III) a non-reducible crosslinker, wherein R₁, R₂, and R₃ are the same or different and are hydrogen or optionally substituted alkyl or cycloalkyl, the method comprising treating Fe polymer gel to cleave at least a portion of the disulphide bonds of the BAC.

56. A method according to claim 55, wherein substantially all the disulphide bonds are cleaved.

57. A method according to claim 55, wherein the polymer gel is an electrophoresis gel.

58. A method according to claim 55, wherein the disulphide bonds are cleaved prior to using the gel to perform electrophoresis on a sample.

59. A method according to claim 55, wherein the disulphide bonds are cleaved by the inclusion of a reducing agent in a sample to be subjected to electrophoresis in the gel.

60. A method according to claim 59, wherein the reducing agent is a thiol.
